(19) United States
(12) Patent Application Publication
(10) Pub. No.: US 2012/0242931 A1
(43) Pub. Date: Sep. 27, 2012

(54) Three-Dimensional Stereoscopic Display Apparatus

(76) Inventors: Jae-Woo Jung, Cheonan-si (KR); Ah-Reum Kim, Cheonan-si (KR); Se-Huhn Hur, Yongin-si (KR); Ho-Seok Son, Incheon (KR)

(21) Appl. No.: 13/224,127

(22) Filed: Sep. 1, 2011

(30) Foreign Application Priority Data
Mar. 25, 2011 (KR) 2011-0026963

(51) Int. Cl. G02F 1/1335

(52) U.S. Cl. 349/62

(57) ABSTRACT

A display apparatus includes a display panel displaying an image. A backlight assembly is disposed under the display panel. A phase delaying plate is disposed on the display panel. The backlight assembly emits a collimated light in a direction substantially perpendicular to the display panel. The phase delaying plate includes a phase delaying layer. The phase delaying layer includes a first pattern delaying a phase of the light passing the display panel by a first phase and a second pattern delaying the phase of the light passing the display panel by a second phase. The second phase is different from the first phase. Accordingly, a spatial crosstalk may be minimized and the optimal viewing angle of the display apparatus may be increased.

### PRIORITY STATEMENT

This application claims priority under 35 U.S.C. §119 to Korean Patent Application No. 10-2011-0026963, filed on Mar. 25, 2011, in the Korean Intellectual Property Office (KIPO), the contents of which are herein incorporated by reference in their entireties.

### BACKGROUND

1. Technical Field

The present invention relates to a display apparatus. More specifically, the present invention relates to a display apparatus displaying a 3-dimensional stereoscopic image.

2. Discussion of the Related Art

A liquid crystal display (LCD) apparatus is a form of flat-panel display device that utilized liquid crystal to display an image by changing the transmissivity of light though individual display pixels. Because the liquid crystal display does not generate its own light, it receives light from a backlight assembly. The LCD is capable of displaying a 2-dimensional image (hereinafter, referred to as a 2D image). LCDs have been devised for displaying a 3-dimensional stereoscopic image (hereinafter, referred to as a 3D image). Such LCDs have the ability to display distinct images to the left and right eyes of the viewers and in so doing can create the perception of depth.

There are presently two distinct varieties of 3D LCDs: a stereoscopic type and an autostereoscopic type. The stereoscopic type display is able to deliver both left eye and right eye images and a pair of 3D glasses worn by the viewer is able to ensure that the viewer's left eye only receives the displayed left eye image and that the viewer's right eye only receives the displayed right eye image. There are two general types of stereoscopic 3D displays, in the first type, the left eye image and the right eye image are polarized to different orientations and the 3D classes include polarized lenses of different orientations on the left and right eye. Because the 3D glasses passively ensure that the left eye only receives the left eye image and the right eye only receives the right eye image, the 3D glasses are known as passive. In the second type, the display device alternates between displaying left eye and right eye images and synchronized shutters on the 3D glasses actively ensure that the appropriate eye receives the appropriate image. These glasses are known as active.

Autostereoscopic 3D displays do not require 3D glasses. There are two types of autostereoscopic 3D displays, the first uses lenticular lenses to project different images in different directions and the second uses a parallax barrier that is situated to stand between the viewer's left eye and the right eye image on the screen and the viewer's right eye and the left eye image on the screen.

In the display apparatus having the polarizing passive 3D glasses, an optical plate emitting polarized light having different orientations is disposed on the display panel which displays the 2D image, and the polarized light having the different orientations of polarization respectively reaches the left and right eyes of the observer wearing the specific 3D glasses. Thus, the observer perceives the 3D image. Since the passive polarizing 3D glasses may be manufactured with a lower cost than the active shitter 3D glasses, the display apparatus having the passive polarizing 3D glasses may be easily commercialized. However, since the optical plate is attached on the display panel to display the 3D image, crosstalk, in which the left eye image may not be filly blocked from the right eye and the right eye image may not be fully blocked by the left eye, may occur according to the viewing angle of the observer. Thus, the display apparatus may have low quality when viewed outside of a preferred viewing angle.

A light shielding layer may be partially formed on the optical plate to prevent image crosstalk and thereby increase the viewing angle. However, the light shielding layer decreases amount of light emitted from the optical plate, so that total luminance decreases.

### SUMMARY

Exemplary embodiments of the present invention provide a display apparatus having a low spatial crosstalk and a high total luminance.

According to an exemplary embodiment of the present invention, a display apparatus includes a display panel displaying an image, a backlight assembly disposed under the display panel, and a phase delaying plate disposed on the display panel. The backlight assembly emits light in a direction substantially perpendicular to the display panel. The phase delaying plate includes a phase delaying layer. The phase delaying layer includes a first pattern delaying a phase of the light passing the display panel by a first phase and a second pattern delaying the phase of the light passing the display panel by a second phase. The second phase is different from the first phase.

For example, the phase delaying plate may further include a base substrate and the phase delaying layer may be formed on the base substrate.

For example, the display apparatus may further include a first polarizing plate and a second polarizing plate. The first polarizing plate may be disposed between the backlight assembly and the display panel and may transmit a first polarized light of the light emitted from the backlight assembly. The second polarizing plate may be disposed between the display panel and the phase delaying plate and may transmit a second polarized light of the light passing through the display panel.

For example, a phase difference between the first and second phases may be λ/2 wherein λ represents the wavelength of the light.

For example, the first pattern may delay the phase of the second polarized light by λ/4, and the second pattern may delay the phase of the second polarized light by 3λ/4.

For example, the first and second patterns are alternately arranged as a bands that run the entire length of the phase delaying plate in the D1 direction.

For example, the backlight assembly may include a plurality of light sources generating the light, a light guide plate, and a grating sheet disposed on the light guide plate. The light guide plate may include an incident surface receiving the light emitted from the light sources, an exiting surface extended from the incident surface and emitting the light, and an opposing surface extended from the exiting surface and being opposite to the incident surface. The grating sheet may transmit a first light of the light emitted from the light guide plate. The first light may be substantially perpendicular to the exiting surface.

For example, the light guide plate may be substantially wedge shaped and may be thinnest at the incident surface and thickest at the opposing surface.

For example, the grating sheet may include a grating pattern defined by a plurality of holes, each of the holes may have a stripe shape, and the holes may be substantially parallel with each other.

For example, the grating pattern may be substantially parallel with respect to the first and second patterns of the phase delaying layer.

For example, the backlight assembly may further include a reflective plate disposed under the light guide plate and reflecting the light.

For example, the backlight assembly may include a plurality of light sources generating the light and an optical filter disposed over the light sources. The optical filter may change a direction of the light emitted from the light source to a direction substantially perpendicular to the display panel.

For example, a prism pattern may be formed on a surface of the optical filter.

For example, the optical filter may be disposed over the light sources so that the prism pattern faces the light sources.

For example, the light sources may include a plurality of light emitting diodes.

For example, the backlight assembly may include a plurality of light modules. Each of the light modules may include a light source generating the light and an optical lens disposed over the light source. The optical lens may refract the light emitted from the light source so that the light exits in the direction substantially perpendicular to the display panel.

For example, a side of the optical lens may have a substantially convex surface.

For example, the light module may further include a blocking plate blocking the light. The blocking plate may be formed at a side portion of the light source and the optical lens.

For example, the display apparatus may further include a diffusing filter disposed on the phase delaying plate and diffusing the light passing through the phase delaying plate.

For example, the display panel may include an upper substrate and a lower substrate, and each of the upper and lower substrates may include a plastic substrate.

According to exemplary embodiments of the present invention, the backlight assembly emits light substantially straight, so that crossover of the left eye image into the observer's right eye and crossover of the right eye image into the observer's left eye is minimized and a spatial crosstalk is reduced. Moreover, the diffusing filter is disposed on the phase delaying plate to generally diffuse the straight light, so that the viewing angle of the display apparatus may be increased.

Moreover, the viewing angle of the display apparatus may be increased without the use of a light shielding layer, such as a black matrix, on the phase delaying plate, and thus total luminance may be prevented from being decreased.

### BRIEF DESCRIPTION OF THE DRAWINGS

The above and other features and aspects of the present invention will become more apparent by describing in detailed exemplary embodiments thereof with reference to the accompanying drawings, in which:

FIG. 1 is a conceptual perspective view illustrating a display apparatus according to an exemplary embodiment of the present invention;

FIG. 2 is an enlarged plan view illustrating an arrangement between a display panel and a phase delaying layer in FIG. 1;

FIG. 3 is a conceptual view illustrating a path of light in the display apparatus of FIG. 1;

FIG. 4A is a cross-sectional view illustrating a backlight assembly taken along a line I-I′ in FIG. 1;

FIG. 4B is a perspective view illustrating a grating sheet in FIG. 4A;

FIG. 5 is a cross-sectional view illustrating a backlight assembly according to an exemplary embodiment of the present invention; and

FIG. 6 is a cross-sectional view illustrating a backlight assembly according to an exemplary embodiment of the present invention.

### DETAILED DESCRIPTION

Hereinafter, exemplary embodiments of the present invention will be explained in detail with reference to the accompanying drawings.

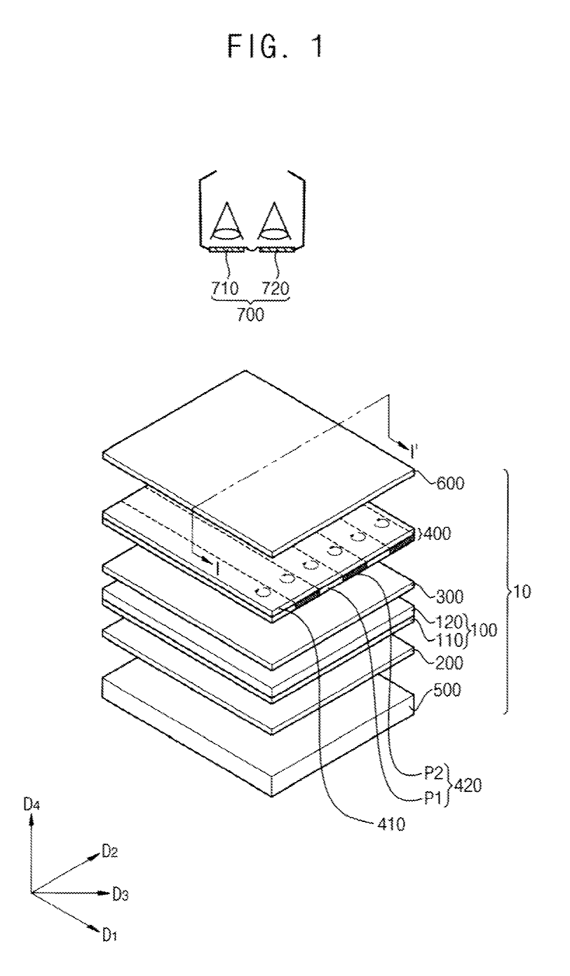

FIG. 1 is a conceptual perspective view illustrating a display apparatus according to an exemplary embodiment of the present invention.

Referring to FIG. 1, the display apparatus 10 includes a display panel 100, a first polarizing plate 200, a second polarizing plate 300, a phase delaying plate 400, a backlight assembly 500 and a diffusing filter 600.

The display panel 100 displays an image using light provided from the backlight assembly 500. For example, the display panel 100 may be a liquid crystal display panel including a first substrate 110, a second substrate 120 facing the first substrate 110, and a liquid crystal layer (not shown) disposed therebetween. The display panel 100 may be disposed over the backlight assembly 500.

The first polarizing plate 200 is disposed between the display panel 100 and the backlight assembly 500. The first polarizing plate 200 polarizes incident light provided from the backlight assembly 500 to provide the display panel 100 with polarized light. The first polarizing plate 200 transmits a first polarized light of the incident light.

The second polarizing plate 300 is disposed on the display panel 100. The second polarizing plate 300 transmits a second polarized light of the light passing through the display panel 100. An orientation of the second polarized light is different from that of the first polarized light. For example, the orientation of the second polarized light may be substantially perpendicular to that of the first polarized light. The first and second polarizing plates 200 and 300 may be attached to the display panel 100, or may be formed on the display panel 100.

The phase delaying plate 400 is disposed on the second polarizing plate 300. The phase delaying plate 400 delays a phase of the second polarized light passing through the second polarizing plate 300. The phase delaying plate 400 includes a base substrate 410 (FIG. 3) and a phase delaying layer 420 (FIG. 3) formed on the base substrate 410. The phase delaying layer 420 includes a first pattern P1 (FIG. 3) delaying a phase of the second polarized light by a first phase, and a second pattern P2 (FIG. 3) delaying the phase of the second polarized light by a second phase. The second phase is different from the first phase. A phase difference between the first and second phases may be λ/2 where λ represents the approximate average wavelength of the light. For example, the first pattern P1 may delay the phase of the second polarized light by λ/4, and the second pattern P2 may delay the phase of the second polarized light by 3λ/4. The base substrate 410 may include a glass.

The first and second patterns P1 and P2 extend along a first direction D1 of the display apparatus 10, and are alternately arranged along a second direction D2. The second direction D2 may be substantially perpendicular to the first direction D1. For example, the first and second patterns P1 and P2 are arranged as bands that run the entire length of the phase delaying plate in the D1 direction. The first pattern P1 delays the phase of the second polarized light to transform the second polarized light to a first circular polarized light. The first pattern P1 may transform the second polarized light to the first circular polarized light in a similar manner as rotating the second polarized light by −45 degrees using a rotator. The second pattern P2 delays the phase of the second polarized light to transform the second polarized light to a second circular polarized light different from the first circular polarized light. The second pattern P2 may transform the second polarized light to the second circular polarized light in a similar manner as rotating the second polarized light by +45 degrees using the rotator. Orientations of the first and second circular polarized lights are opposite to each other. For example, the first circular polarized light may be a left circular polarized light, and the second circular polarized light may be a right circular polarized light. Alternatively, the first circular polarized light may be the right circular polarized light, and the second circular polarized light may be the left circular polarized light.

Furthermore, the first and second patterns P1 and P2 may be arranged in a pattern different form the bands that run the entire length of the phase delaying plate in the D1 direction. The first and second patterns P1 and P2 may be alternately formed along the first and second directions D1 and D2. For example, the first and second patterns P1 and P2 may be arranged in a dot pattern.

The display apparatus 10 displays a 2-dimensional (2D) image, but an observer wearing polarizing glasses 700 may receive the first and second circular polarized lights to both eyes of the observer respectively through the polarizing glasses 700. The polarizing glasses 700 include a first eye part 710 transmitting the first circular polarized light and blocking the second circular polarized light. The polarizing glasses 700 further include a second eye part 720 transmitting the second circular polarized light and blocking the first circular polarized light. Thus, the observer watches the first circular polarized light only through the first eye, and the second circular polarized light only through the second eye. Thus, a brain of the observer perceives substantially a 3-dimensional stereoscopic image. However, the brain of the observer may perceive a 2D non-stereoscopic image when not wearing the polarizing glasses 700.

The backlight assembly 500 is disposed under the first polarizing plate 200, and emits light substantially straight in a direction D4. The light is substantially perpendicular to the plane of the display panel 100. The backlight assembly 500 emits the light as a collimated beam comprised of substantially parallel rays. This collimated light in which constituent beams travel substantially in parallel may be referred to herein simply as “straight light.” For example, the straight light emitted from the backlight assembly 500 is not diffused and is incident into the display panel 100 without being diffused in the direction D4 which is substantially perpendicular to the display panel 100.

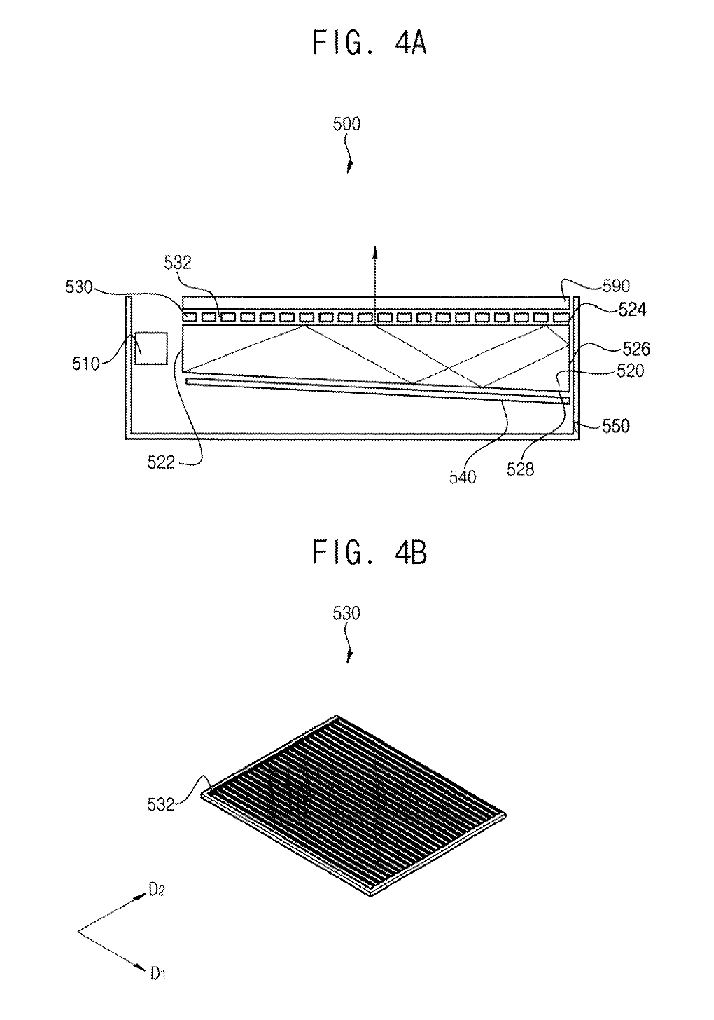

The backlight assembly 500 may include any backlight structure that may emit the straight light. According to an exemplary embodiment, the backlight assembly includes a light guide plate having a wedge type to emit the straight light. The backlight assembly 500 is explained in detail referring to FIGS. 4A and 4B.

The diffusing filter 600 is disposed on the phase delaying plate 400. The diffusing filter 600 diffuses the light passing through the phase delaying plate 400 so that total luminance may be increased. For example, the diffusing filter 600 diffuses the straight light passing through the phase delaying plate 400, so that an optimal viewing angle of the display apparatus may increase. The diffusing filter 600 may be a prism sheet having a prism shape on a surface of the prism sheet.

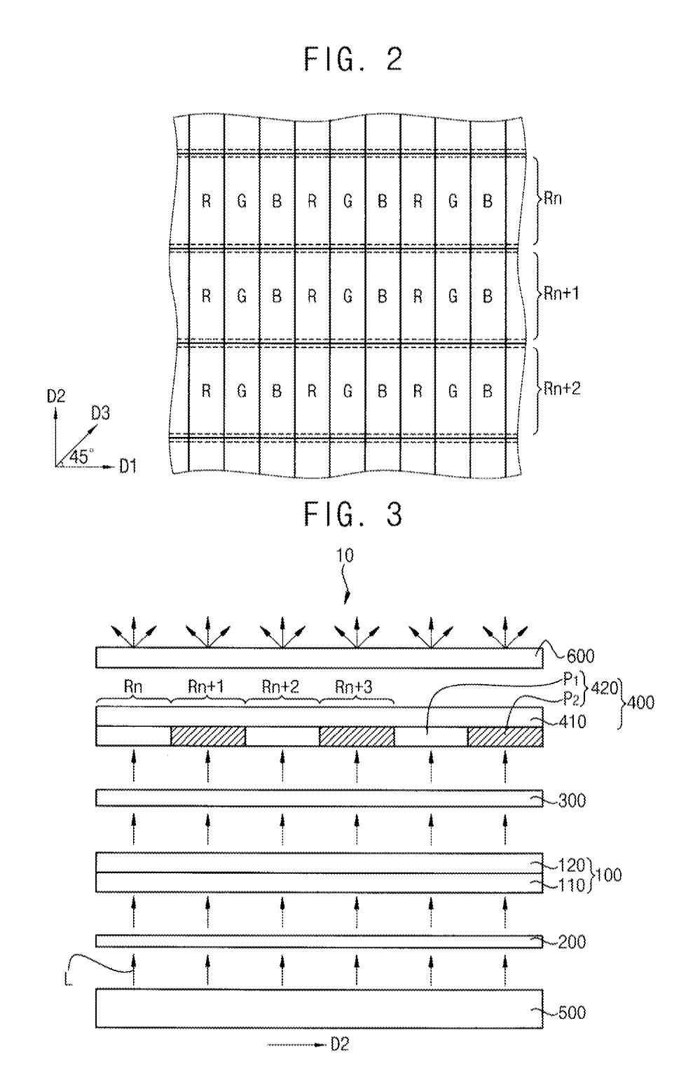

FIG. 2 is an enlarged plan view illustrating an arrangement between a display panel and a phase delaying layer in FIG. 1. FIG. 3 is a conceptual view illustrating a path of light in the display apparatus of FIG. 1.

Referring to FIGS. 2 and 3, the display panel 100 includes a first substrate 110 having a thin-film transistor (TFT, not shown) and a pixel electrode (not shown), and a second substrate 120 facing the first substrate 110. The first and second substrates 110 and 120 may each include a flexible substrate. For example, the first and second substrates 110 and 120 may each include a plastic substrate made of a fiber reinforced plastic, acrylic, or polycarbonate. A display element is disposed between the first and second substrates 110 and 120 to control a transmissivity of the light provided from the backlight assembly 500, and thus the display panel 100 may display an image. The display element may be, for example, a liquid crystal. The first polarizing plate 200 is combined with a light incident surface of the display panel 100 receiving the light from the backlight assembly 500. The second polarizing plate 300 is combined with a light exiting surface facing the light incident surface. For example, the first polarizing plate 200 is combined with an external face of the first substrate 110 that is the light incident surface, and the second polarizing plate 300 is combined with an external face of the second substrate 120 that is the light exiting surface.

The display panel 100 includes a plurality of pixel cells. Each of the pixel cells includes a pixel electrode and a color filter displaying a color. The color filter may be formed on the first substrate 110, or formed on the second substrate 120. The pixel cells may include a red (R) pixel, a green (G) pixel and a blue (B) pixel respectively emitting red light, green light and blue light. The R, G and B pixels are alternately arranged along the first direction D1 to define an n-th pixel line Rn. R, G and B pixels arranged along the second direction D2 of the R, G and B pixels define an (n+1)-th pixel line Rn+1 arranged along the second direction D2 from the n-th pixel line Rn. An (n+2)-th pixel line Rn+2 is arranged along the second direction D2 from the (n+1)-th pixel line Rn+1.

In the display panel for a 3D display, an image for a left eye and an image for a right eye are alternately displayed along the pixel lines. For example, the image for the left eye is displayed in the n-th pixel line Rn, and the image for the right eye is displayed in the (n+1)-th pixel line Rn+1.

First patterns P1 of the phase delaying layer 420 extend along the first direction D1 and the first patterns P1 are spaced apart from each other along the second direction D2. For example, the first patterns P1 are disposed on the nth and (n+2)-th pixel lines Rn and Rn+2. The second pattern P2 of the phase delaying layer 420 is disposed between the first patterns P1 adjacent to each other, and thus the second pattern P2 is disposed on the (n+1)-th pixel line Rn+1. Therefore, the first pattern P1 delays the phase of the second polarized light corresponding to the image for the left eye, and a second pattern P2 delays the phase of the second polarized light corresponding to the image for the right eye. Using the polarizing glasses, the image for the left eye enters into the left eye of the observer and the image for the right eye enters into the right eye of the observer.

A phase delaying axis of the phase delaying layer 420 has an inclination with respect to a polarized light absorbing axis of the second polarizing plate 300. For example, when the phase delaying axis extends along the first direction D1 or the second direction D2, the polarized light absorbing axis may extend along a third direction D3 between the first and second directions D1 and D2. For example, the phase delaying axis has an inclination of about 45 degrees with respect to the polarized light absorbing axis, so that the phase delaying layer circularly polarizes the second polarized light.

The backlight assembly 500 emits straight (collimated) light L in a direction substantially perpendicular to the display panel 100. Due to a straight path of the straight light, the light passing through the n-th pixel line Rn passes through the first pattern P1 of the phase delaying layer 420, and light passing through the (n+1)-th pixel line Rn+1 passes through the second pattern P2 of the phase delaying layer 420. There may be little to no light passing thorough both the n-th pixel line Rn and second pattern P2 of the phase delaying layer 420. Similarly, there may be little to no light passing though both the (N+1)-th pixel line Rn+1 and the first pattern P1 of the phase delaying layer 420. In this way, crosstalk between the image for the left eye and the image for the right eye is reduced or prevented regardless of a position of the observer's eyes, and thus a spatial crosstalk can be minimized. Moreover, although the display panel 100 includes a flexible substrate that may have a curved surface created by an external pressure, crosstalk between the image for the left eye and the image for the right eye is still minimized. Therefore, the display apparatus may have a relatively large optimal viewing angle.

The diffusing filter 600 is disposed on the phase delaying plate 400 to diffuse the light passing through the phase delaying plate 400. For example, the light passing through the phase delaying plate 400 is collimated and thus has a straight path, which is substantially the same as the straight light emitted from the backlight assembly 500. However, according to exemplary embodiments of the present invention, the diffusing filter 600 is disposed on the phase delaying plate 400 to generally diffuse the straight light, so that the optimal viewing angle of the display apparatus may increase. Furthermore, the spatial crosstalk may be minimized and the optimal viewing angle of the display image may efficiently increase.

Moreover, conventionally, a light shielding layer is partially formed on a phase delaying plate to increase the optimal viewing angle, which is caused by the crosstalk. However, the light shielding layer decreases total luminance. However, the optimal viewing angle of the display apparatus may be increased without the light shielding layer, such as a black matrix, on the phase delaying plate 400, and thus total luminance may be prevented from decreasing.

Hereinafter, the backlight assembly 500 is explained in detail referring to FIGS. 4A and 4B.

FIG. 4A is a cross-sectional view illustrating a backlight assembly taken along a line I-I′ in FIG. 1. FIG. 4B is a perspective view illustrating a grating sheet in FIG. 4A.

Referring to FIGS. 1, 4A and 4B, the backlight assembly 500 includes a light source 510, a light guide plate 520, a grating sheet 530 and a reflective plate 540.

The light source 510 may include a plurality of light emitting diodes (“LEDs”), which generates light by using an external driving power. The LED is a point light source having directivity. Light emitted from LED spreads out from the point light source. The light sources 510 are disposed adjacent to the light guide plate 520.

The light source may include LEDs which form point light sources. Alternatively, the light source may include a line light source such as a fluorescent tube.

The light guide plate 520 converts the incident light having point light source distribution or line light source distribution into an exiting light that is collimated and has a substantially plane light source distribution. The light guide plate 520 includes an incident surface 522, an exiting surface 524 and an opposing surface 526. The incident surface 522 is formed at a side of the light guide plate and receives the incident light. The light sources 510 are disposed adjacent to the incident surface 522. The exiting surface 524 is extended from an upper side of the incident surface 522 and the exiting light exits from the exiting surface 524. The opposing surface 526 is extended from the exiting surface 524 and is opposite to the incident surface 522. The light guide plate 520 may have a low or moderate grade wedge shape. The light guide plate 520 may be thinnest at the incident surface 522 and thickest at the opposing surface 526. A reflective layer for reflecting the light is formed on the opposing surface 526.

The reflective plate 540 is disposed under the light guide plate 520 and reflects the light emitted from the light guide plate. For example, the light, which is incident to the light guide plate, partially exits through the exiting surface of the light guide plate and partially exits through a bottom surface 528 of the light guide plate, which is opposite to the exiting surface. Thus, the reflective plate re-reflects the light exiting through the bottom surface 528 and guides the light into the exiting surface 524 of the light guide plate.

The grating sheet 530 is disposed on the exiting surface 524 of the light guide plate. The grating sheet 530 includes a grating pattern 532 which is defined by a plurality of holes, and each of the holes extends along the first direction D1 and runs substantially parallel with the other holes with respect to the second direction D2. For example, the grating pattern 532 has a plurality of stripes, which extends along the first direction D1 and is substantially parallel with each other with respect to the second direction D2, and the stripes have a small distance between each other relative to their thickness. The grating sheet 530 transmits light substantially perpendicular to the exiting surface 524 among the light emitted from the light guide plate 520. For example, the collimated straight light that is substantially perpendicular to the exiting surface 524 passes through the grating pattern 532 of the grating sheet 530, and is incident to the first polarizing plate 200. Therefore, the backlight assembly emits the collimated straight light in the direction D4 substantially perpendicular to the display panel 100.

The backlight assembly 500 further includes an optical sheet 590, which is disposed on the grating sheet 530 and enhances optical characteristics of the straight light.

The backlight assembly 500 further includes a receiver 550. The receiver 550 has a shape of a rectangular frame, and receives the light source 510, the light guide plate 520, the grating sheet 530 and the reflective plate 540.

Hereinafter, a path of the light in the backlight assembly 500 is explained in detail. The light emitted from the light source 510 is incident into the incident surface 522 of the light guide plate 520. The incident light is totally reflected on the exiting surface 524 and the bottom surface 528 in the light guide plate 520. Since the thickness of the light guide plate 520 is graded to be greater at the opposing surface 526, the incident light does not exit out of the light guide plate 520 until arriving at the opposing surface 526. When the totally reflected light arrives at the opposing surface 526, the light is reflected by the reflective layer formed on the opposing surface. The light, which is reflected on the opposing surface 526 and advances to the incident surface 522 again, may not be totally reflected on the exiting surface 524 and the bottom surface 528 in advancing to the incident surface 522 since the thickness of the light guide plate 520 is grated to be lesser at the incident surface 522. Thus, the light, which advances from the opposing surface to the incident surface, exits through the exiting surface 524 or the bottom surface 528.

Among the light exiting through the exiting surface 524 of the light guide plate 520, light substantially perpendicular to the exiting surface 524 advances to the first polarizing plate 200 through the grating pattern 532 of the grating sheet 530. The grating sheet 530 is disposed on the exiting surface 524. Thus, the backlight assembly 500 emits the light as collimated light.

The light, which exits through a bottom surface 528 of the light guide plate, is reflected by the reflective plate 540 disposed under the light guide plate 520. Thus, the light reflected by the reflective plate 540 passes through the exiting surface 524, and is collimated as it passes through the grating sheet 530.

The incident light, which is incident into the incident surface 522 of the light guide plate, is totally reflected on the exiting surface 524 and the bottom surface 528 in the light guide plate, and does not exit out of the light guide plate until arriving at the opposing surface 526. Thus, the incident lights are uniformly overlapped with each other, and thus the light may uniformly and efficiently exits.

As mentioned the above, the backlight assembly 500 emits the collimated light being straight, so that the image for the left eye does not enter the viewer's right eye and the image for the right eye does not enter the viewer's left eye, and a spatial crosstalk may be minimized. Moreover, the diffusing filter 600 is disposed on the phase delaying plate 400 to generally diffuse the straight light, so that the optimal viewing angle of the display apparatus may increase. Furthermore, the spatial crosstalk may be minimized, the optimal viewing angle of the display image may efficiently increase, and total luminance may be prevented from decreasing.

The light guide plate 520 in the present exemplary embodiment has the wedge shape, but the shape of the light guide plate 520 is not limited thereto. The shape of the light guide plate may be modified such that the light guide plate may emit the straight light.

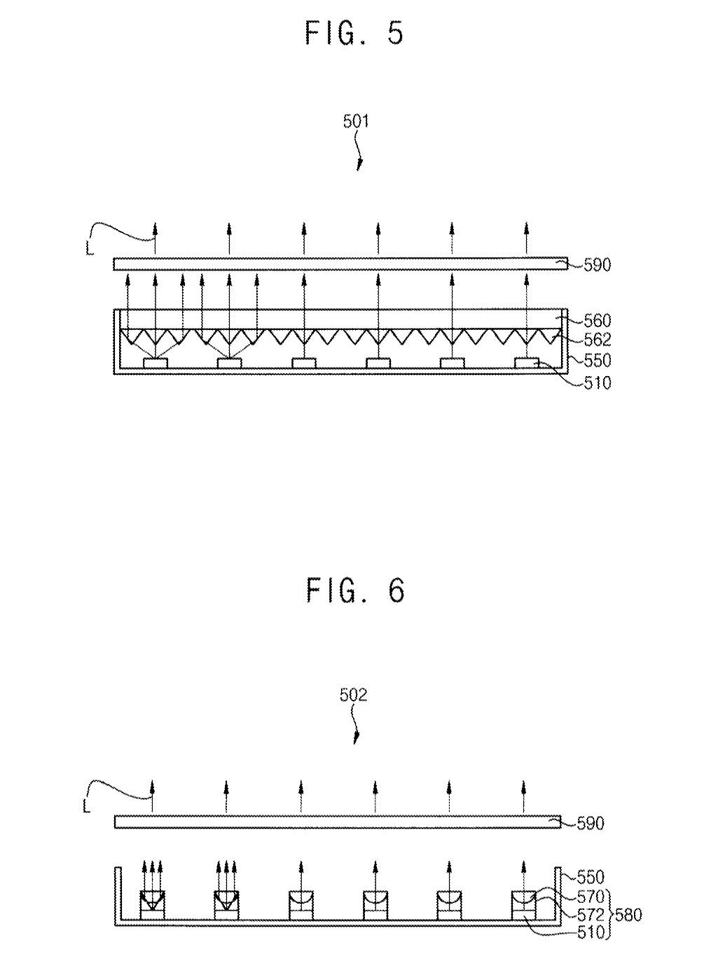

FIG. 5 is a cross-sectional view illustrating a backlight assembly according to an exemplary embodiment of the present invention. The display apparatus according may be substantially the same as the display apparatus described above with respect to FIGS. 1 to 4B, except for a backlight assembly. Thus, the same numerical reference will be used and the repetitive explanation will be omitted.

Referring to FIG. 5, a backlight assembly 501 includes a light source 510, an optical filter 560 and a receiver 550.

The light source 510 may include a plurality of light emitting diodes (“LEDs”), which generates light by an external driving power. The light source 510 is disposed under the optical filter 560, and emits the light to the optical filter 560.

The optical filter 560 changes a direction of the light emitted from the light source 510 to a direction D4 substantially perpendicular to the display panel 100. The optical filter 560 converts the light emitted from the light source 510 to light L being collimated (i.e. straight). For example, the optical filter 560 includes a prism pattern 562, which extends in the first direction D1 on a surface of the optical filter. The optical filter 560 is disposed over the light source 510, so that the prism pattern 562 faces the light source 510. The optical filter 560 converts the light emitted from the light source 510 to the direction D4 substantially perpendicular to the optical filter 560 through the prism pattern 562. For example, the light emitted from the light source 510 is totally reflected at the prism pattern 562 and advances in the direction D4 substantially perpendicular to the optical filter 560.

The optical filter 560 may include the prism pattern 562 on the surface of the optical filter 560, but is not limited thereto. The pattern included in the optical filter may be modified such that the optical filter may convert the light incident into the optical filter to the straight light. Moreover, the light source in may include the point light source, but alternatively it may include a line light source.

The backlight assembly 501 further includes an optical sheet 590 disposed on the optical filter 560 and enhancing optical characteristics of the straight light.

The receiver 550 has a shape of a rectangular frame, and receives the light source 510 and the optical filter 560.

As mentioned above, the backlight assembly 501 emits the light being straight, so that a spatial crosstalk may be minimized. Moreover, the optimal viewing angle of the display image may efficiently increase, and total luminance may be prevented from decreasing. Furthermore, the light guide plate may be omitted, so that total size of the display apparatus may decrease.

FIG. 6 is a cross-sectional view illustrating a backlight assembly according to an exemplary embodiment of the present invention. The display apparatus may be substantially the same as the display apparatus described above with reference to FIGS. 1 to 4B, except for a backlight assembly. Thus, the same numerical reference will be used and the repetitive explanation will be omitted.

Referring to FIG. 6, a backlight assembly 502 includes light modules 580 and a receiver 550. Each of the light modules 580 includes a light source 510 and an optical lens 570.

In the light module 580, the optical lens 570 is disposed over the light source 510 and refracts the light emitted from the light source 510 to emit the light in the direction D4 substantially perpendicular to the display panel 100. The optical lens 570 converts the light emitted from the light source 510 to light L being straight. For example, a side of the optical lens 570 has a parabolic shape or a shape substantially the same as a curved surface of a convex lens (i.e. a convex shape), and the optical lens 570 is disposed over the light source 510 so that the curved surface faces the light source 510. A blocking plate 572 is formed at a side portion of the light source 510 and optical lens 570. The light emitted from the light source 510 is refracted on the curved surface of the optical lens 570 to the direction D4 substantially perpendicular to the display panel 100, and light out of a range of the optical lens 570 is blocked by the blocking plate 572.

In this arrangement, the distance between the light source 510 and the optical lens 570 may be equal to a focal length of the optical lens 570. Alternatively, or additionally, a parabolic reflector may be placed below the light source 510 to project the light emanating therefrom as collimated light.

The optical lens 570 described above with respect to FIG. 6 may have a curved surface of a convex lens, but is not limited thereto. The shape of the optical lens 570 may be modified such that the optical lens may convert the light incident into the optical lens to the straight light.

The backlight assembly 502 may further include an optical sheet 590 disposed on the light modules 580 and enhancing optical characteristics of the straight light.

The receiver 550 has a shape of a rectangular frame, and receives the light modules 580.

As mentioned above, the backlight assembly 502 emits the light as collimated light that is straight, so that a spatial crosstalk may be minimized. Moreover, the optimal viewing angle of the display image may efficiently increase, and total luminance may be prevented from decreasing.

According to the exemplary embodiment of the present invention described above, the backlight assembly emits the light as collimated that is straight, so that the image for the left eye and the image for the right eye are exclusively received in the corresponding observer's eyes, and a spatial crosstalk may be minimized. Moreover, the diffusing filter is disposed on the phase delaying plate to generally diffuse the straight light, so that the optimal viewing angle of the display apparatus may increase.

Moreover, the optimal viewing angle of the display apparatus may be increased without the light shielding layer, such as a black matrix, on the phase delaying plate, and thus total luminance may be prevented from decreasing.

The foregoing is illustrative of the present disclosure and is not to be construed as limiting thereof. Although a few exemplary embodiments of the present invention have been described, those skilled in the art will readily appreciate that many modifications are possible in the exemplary embodiments without materially departing from the present disclosure.

What is claimed is:

1. A display apparatus comprising:
a display panel displaying an image;
a backlight assembly disposed proximate to the display panel and emitting collimated light in a direction substantially perpendicular to a plane of the display panel; and
a phase delaying plate disposed on an opposite side of the display panel relative to the backlight assembly, the phase delaying plate including a phase delaying layer, the phase delaying layer including a first pattern delaying a phase of the light passing the display panel by a first phase and a second pattern delaying the phase of the light passing the display panel by a second phase, the second phase being different from the first phase.

2. The display apparatus of claim 1, wherein the phase delaying plate further comprises a base substrate, and the phase delaying layer is formed on the base substrate.

3. The display apparatus of claim 1, further comprising:
a first polarizing plate disposed between the backlight assembly and the display panel, and transmitting a first polarized light of the light emitted from the backlight assembly; and
a second polarizing plate disposed between the display panel and the phase delaying plate, and transmitting a second polarized light of the light passing through the display panel,
wherein the first and second polarized light have a different orientation of polarization.

4. The display apparatus of claim 1, wherein the first and second polarized light are orthogonally oriented.

5. The display apparatus of claim 1, wherein a phase difference between the first and second phases is λ/2, where λ is approximately equal to an average wavelength of the light.

6. The display apparatus of claim 3, wherein the first pattern delays the phase of the second polarized light by λ/4, and the second pattern delays the phase of the second polarized light by 3λ/4, where λ is approximately equal to an average wavelength of the light.

7. The display apparatus of claim 1, wherein the first and second patterns are alternately arranged as bands that run the length of the phase delaying plate.

8. The display apparatus of claim 1, wherein the backlight assembly comprises:
a plurality of light sources generating the light;
a light guide plate including an incident surface receiving the light emitted from the light sources, an exiting surface extended from the incident surface and emitting the light, and an opposing surface extended from the exiting surface and being opposite to the incident surface; and
a grating sheet disposed on the light guide plate and transmitting a first light of the light emitted from the light guide plate, the first light advancing substantially perpendicular to the exiting surface.

9. The display apparatus of claim 8, wherein the light guide plate is wedge shaped and has a grade that is thinnest at the incident surface and thickest at the opposing surface.

10. The display apparatus of claim 8, wherein the grating sheet comprises a grating pattern defined by a plurality of holes, each of the holes has a stripe shape, and the holes are substantially parallel with each other.

11. The display apparatus of claim 10, wherein the grating pattern is substantially parallel with the first and second patterns of the phase delaying layer.

12. The display apparatus of claim 8, wherein the backlight assembly further comprises a reflective plate disposed under the light guide plate.

13. The display apparatus of claim 1, wherein the backlight assembly comprises:
a plurality of light sources generating the light; and
an optical filter disposed over the light sources, the optical filter changing a direction of the light emitted from the light sources to a direction substantially perpendicular to the display panel.

14. The display apparatus of claim 13, wherein a prism pattern is formed on a surface of the optical filter.

15. The display apparatus of claim 13, wherein the light sources comprise a plurality of light emitting diodes.

16. The display apparatus of claim 1, wherein the backlight assembly comprises a plurality of light modules, each of the light modules comprising:
a light source generating the light; and
an optical lens disposed over the light source, the optical lens refracting the light emitted from the light source such that the light exits the optical lens in the direction substantially perpendicular to the display panel.

17. The display apparatus of claim 16, wherein the optical lens has a convex surface.

18. The display apparatus of claim 1, further comprising a diffusing filter disposed on the phase delaying plate, the diffusing filter diffusing the light passing through the phase delaying plate.

19. A display apparatus comprising:
a display panel;
a backlight assembly disposed proximate to the display panel and emitting collimated light in a direction substantially perpendicular to a plane of the display panel; and
a phase delaying plate disposed on an opposite side of the display panel relative to the backlight assembly for delaying the phase of the collimated light by two different amounts.

20. The display device of claim 19, wherein the phase delaying plate includes a first pattern for delaying the phase of the collimated light by a first amount and a second pattern for delaying the phase of the collimated light by a second amount different from the first amount.

21. The display device of claim 20, wherein a left eye image is generated by a first portion of the display panel and the collimated light that illuminates the first portion of the display panel passes through the first pattern of the phase delaying plate and a right eye image is generated by a second portion of the display panel and the collimated light that illuminates the second portion of the display panel passes through the second pattern of the phase delaying plate such that little to no light that illuminates the first portion of the display device passes through the second pattern of the phase delaying plate and little to no light that illuminates the second portion of the display panel passes through the first pattern of the phase delaying plate.
